(19) United States
(12) Patent Application Publication
(10) Pub. No.: US 2024/0380514 A1
(43) Pub. Date: Nov. 14, 2024

(54) TRANSMIT FLOW FOR SUPPORTING PROBABILISTIC SHAPING

(71) Applicant: QUALCOMM Incorporated, San Diego, CA (US)

(72) Inventors: Wei YANG, San Diego, CA (US); Jing JIANG, San Diego, CA (US); Hobin KIM, San Diego, CA (US); Jae Won YOO, San Diego, CA (US); Hari SANKAR, San Diego, CA (US); Pinar SEN, San Diego, CA (US)

(21) Appl. No.: 18/316,161

(22) Filed: May 11, 2023

(51) Int. Cl. H04L 1/00

(52) U.S. Cl. CPC H04L 1/0042; H04L 1/0057; H04L 1/0067; H04L 1/0076

(57) ABSTRACT

A method for wireless communication at a transmitting wireless device and related apparatus are provided. In the method, the device determines, based on the first parameter associated with a Forward Error Correction (FEC) process and a second parameter associated with a probabilistic shaping process, the transport block (TB) size for a TB associated with a signal to be transmitted, and performs the probabilistic shaping process on a first set of data bits of the signal on the TB to obtain a second set of transmit bits. The TB cyclic redundancy check (CRC) is inserted into the TB before or after the probabilistic shaping process, and the probabilistic shaping process is applied on the TB level across multiple code blocks (CBs) associated with the TB or on the CB level individually inside each CB of the multiple CBs. The device further transmits the signal using the second set of transmit bits.

### TECHNICAL FIELD

The present disclosure relates generally to communication systems, and more particularly, to the transmit flow for supporting probabilistic shaping in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a transmitting wireless device. The apparatus may include at least one memory and at least one processor coupled to the at least one memory. Based at least in part on information stored in the at least one memory, the at least one processor may be configured to determine, based at least in part on a first parameter associated with a Forward Error Correction (FEC) process and a second parameter associated with a probabilistic shaping process, a transport block (TB) size for a TB associated with a signal to be transmitted to a receiving wireless device; perform the probabilistic shaping process on a first set of data bits of the signal on the TB to obtain a second set of transmit bits, where a TB cyclic redundancy check (CRC) is inserted into the TB before or after the probabilistic shaping process, and where the probabilistic shaping process is applied on a TB level across multiple code blocks (CBs) associated with the TB or on a CB level individually inside each CB of the multiple CBs; and transmit, to the receiving wireless device, the signal using the second set of transmit bits.

In an aspect of the disclosure, a method, a computer-readable medium, and an apparatus are provided for wireless communication at a receiving wireless device. The apparatus may include at least one memory and at least one processor coupled to the at least one memory. Based at least in part on information stored in the at least one memory, the at least one processor may be configured to receive, from a transmitting wireless device, a set of transmit bits associated with a signal; demodulate the set of transmit bits to extract a set of demodulated bits; and perform, based on the set of demodulated bits and a TB associated with the set of demodulated bits, an inverse probabilistic shaping process to obtain a set of data bits for the signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating various aspects of processing information bits at the transmitter side in wireless communication.

FIG. 4B is a diagram illustrating various aspects of processing the received signal at the receiver side in wireless communication.

FIG. 5 is a diagram illustrating example constellation points with different amplitudes.

FIG. 6A is a diagram illustrating an example of geometric shaping.

FIG. 6B is a diagram illustrating an example of probabilistic shaping.

FIG. 7 is a diagram illustrating the bit-to-symbol mapping.

FIG. 8A is a diagram illustrating various aspects in a 5G NR data flow.

FIG. 8B is a diagram illustrating various aspects affected by probabilistic shaping in accordance with the present disclosure.

FIG. 9A is a diagram illustrating an example of TB-level shaping in accordance with various aspects of the present disclosure.

FIG. 9B is a diagram illustrating an example of CB-level shaping in accordance with various aspects of the present disclosure.

FIG. 10 is a diagram illustrating an example of rate matching process using the same channel code and coded CB size in accordance with various aspects of the present disclosure.

FIG. 11 is a call flow diagram illustrating a method of wireless communication in accordance with various aspects of the present disclosure.

FIG. 12 is a flowchart illustrating methods of wireless communication at a transmitting wireless device in accordance with various aspects of the present disclosure.

FIG. 13 is a flowchart illustrating methods of wireless communication at a transmitting wireless device in accordance with various aspects of the present disclosure.

FIG. 14 is a flowchart illustrating methods of wireless communication at a receiving wireless device in accordance with various aspects of the present disclosure.

FIG. 15 is a flowchart illustrating methods of wireless communication at a receiving wireless device in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

Various aspects relate generally to communication systems. Some aspects more specifically relate to the transmit flow for supporting probabilistic shaping in wireless communication. Particular aspects of the subject matter described in this disclosure can be implemented to realize one or more of the following potential advantages. In some examples, by offering flexible and adaptive methods for integrating probabilistic shaping into existing and new communication systems, the described techniques can be used to improve the efficiency, throughput, and latency of wireless communication. In some aspects, by offering various options for TB CRC insertion, the described techniques allow the TB CRC insertion to be implemented according to the hardware and system requirements and help balance the need for error detection with hardware reuse and system compatibility. In some aspects, by offering options for applying the probabilistic shaping at either the TB level or the CB level, the described techniques allow the system to be customized according to different use cases and requirements.

In some examples, a transmitting wireless device may determine, based at least in part on a first parameter associated with an FEC process and a second parameter associated with a probabilistic shaping process, a TB size for a TB associated with a signal to be transmitted to a receiving wireless device, and perform the probabilistic shaping process on a first set of data bits of the signal on the TB to obtain a second set of transmit bits. The TB CRC may be inserted into the TB before or after the probabilistic shaping process, and the probabilistic shaping process may be applied on the TB level across multiple CBs associated with the TB or on the CB level individually inside each CB of the multiple CBs. The transmitting wireless device may further transmit, to the receiving wireless device, the signal using the second set of transmit bits.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

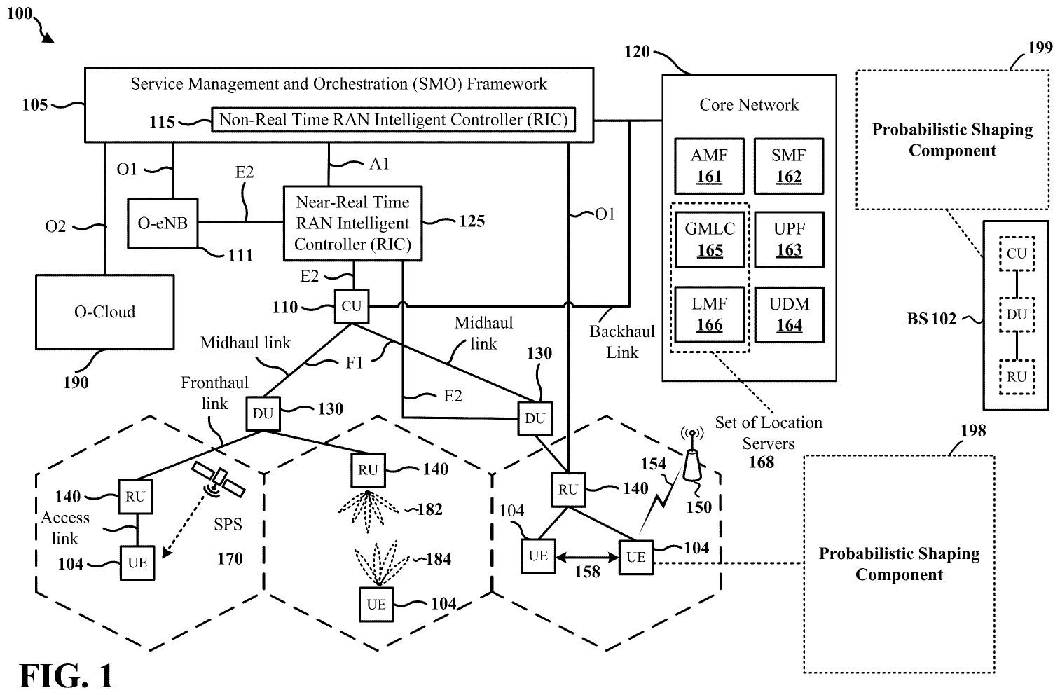

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a probabilistic shaping component 198. The probabilistic shaping component 198 may be configured to determine, based at least in part on a first parameter associated with an FEC process and a second parameter associated with a probabilistic shaping process, a TB size for a TB associated with a signal to be transmitted to a receiving wireless device; perform the probabilistic shaping process on a first set of data bits of the signal on the TB to obtain a second set of transmit bits, where a TB CRC is inserted into the TB before or after the probabilistic shaping process, and wherein the probabilistic shaping process is applied on a TB level across multiple CBs associated with the TB or on a CB level individually inside each CB of the multiple CBs; and transmit, to the receiving wireless device, the signal using the second set of transmit bits.

In certain aspects, the base station 102 may include a probabilistic shaping component 199. The probabilistic shaping component 199 may be configured to receive, from a transmitting wireless device, a set of transmit bits associated with a signal; demodulate the set of transmit bits to extract a set of demodulated bits; and perform, based on the set of demodulated bits and a TB associated with the set of demodulated bits, an inverse probabilistic shaping process to obtain a set of data bits for the signal. Although the following description may be focused on 5G NR, the concepts described herein may be applicable to other similar areas, such as LTE, LTE-A, CDMA, GSM, and other wireless technologies.

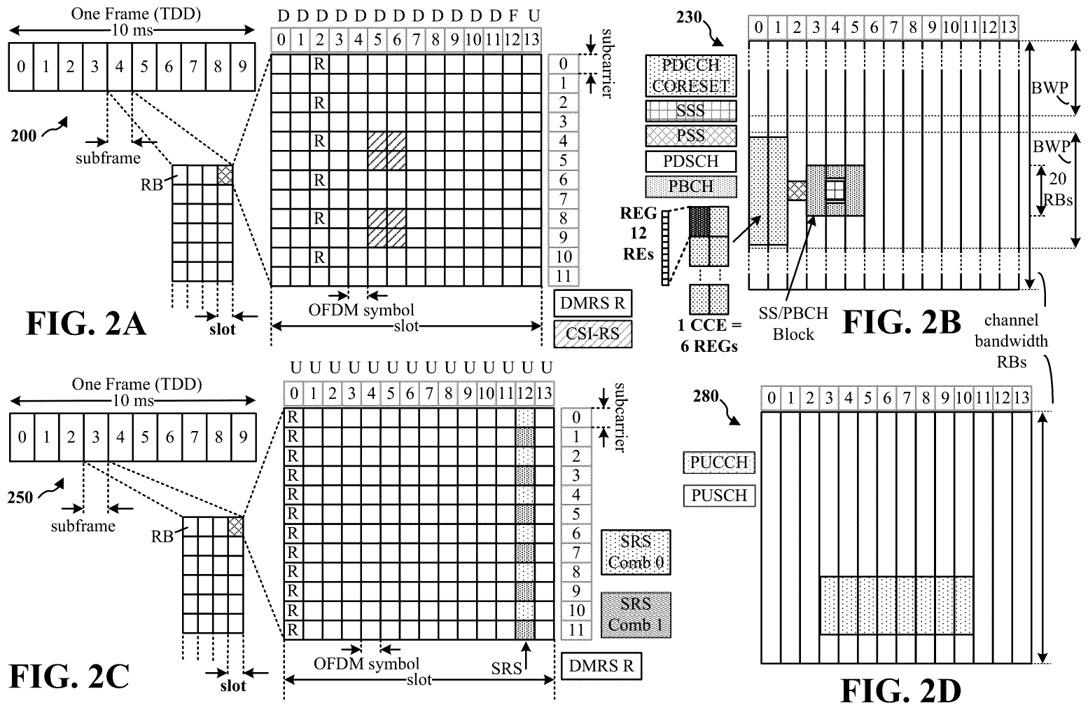

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

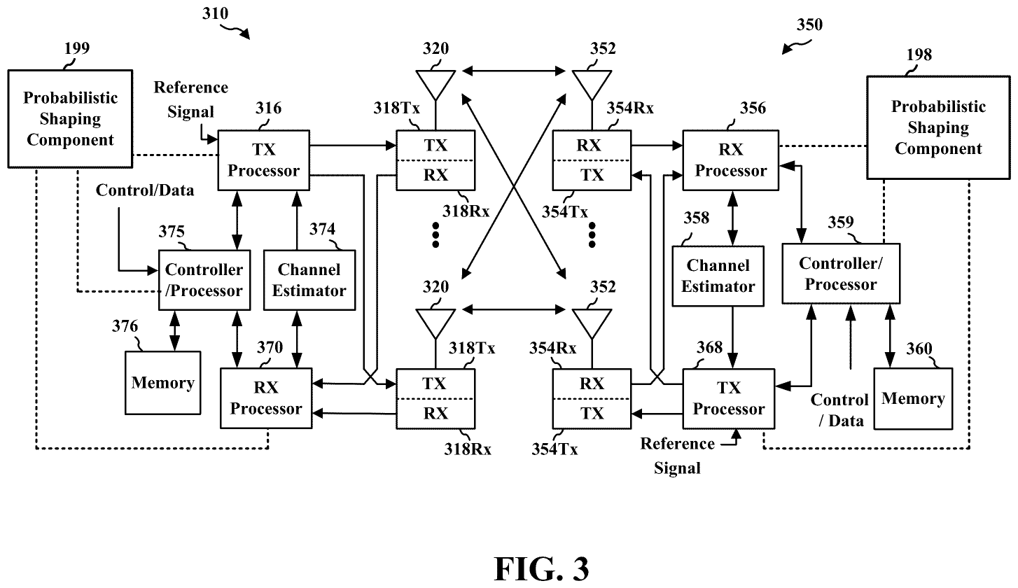

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the probabilistic shaping component 198 of FIG. 1.

At least one of the TX processor 316, the RX processor 370, and the controller/processor 375 may be configured to perform aspects in connection with the probabilistic shaping component 199 of FIG. 1.

Example aspects presented herein provide methods and apparatus to support probabilistic constellation shaping with a wireless transmission flow. Among other examples of wireless technologies for which the probabilistic constellation shaping may be applied, the wireless transmission flow may be based upon 5G NR. Although example aspects are described in connection with 5G NR in order to illustrate the concept, the aspects may also be applied for other wireless communication systems.

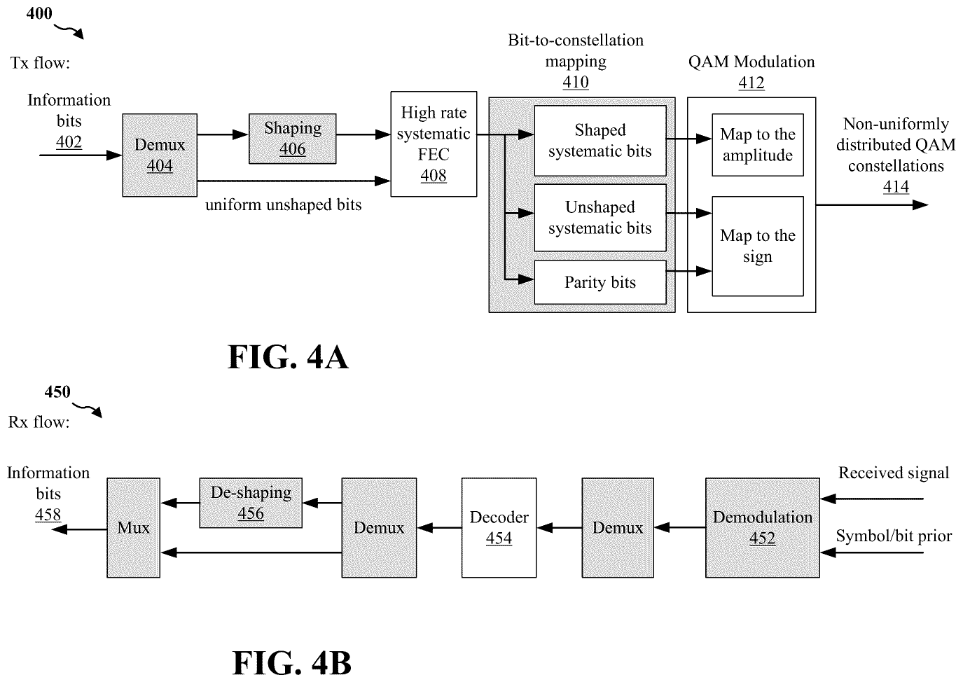

Information bits may go through various processing at a transmitter before being transmitted as symbols. FIG. 4A is a diagram 400 illustrating various aspects of processing information bits at the transmitter side in wireless communication. In FIG. 4A, the information bits 402 received at the transmitter may undergo various types of processing to ensure the successful and efficient transfer of the information. The processing may include the demultiplexing process (Demux 404), which involves the separation of multiple data streams that have been multiplexed together, and the shaping process 406. In some aspects, the shaping process 406 may be probabilistic shaping (also known as “distribution matching”), which may involve shaping the probability distribution of the information bits and/or modulated symbols. After the shaping process 406, the shaped bits and unshaped bits may be encoded by, for example, an FEC encoder 408, and the encoded signal may be input to the Bit-to-constellation mapping 410. The Bit-to-constellation mapping 410, also known as the “modulation,” converts the information bits into modulation symbols that can be transmitted over the channel. Then, in a digital modulation scheme, such as Quadrature Amplitude Modulation (QAM) 412, the bits may be mapped to constellation points (e.g., non-uniformly distributed QAM constellations 414) representing specific amplitudes and phases of the carrier signal. This mapping helps the transmitted signal to carry the information in a manner to be effectively demodulated at the receiver.

FIG. 4B is a diagram 450 illustrating various aspects of processing the received signal at the receiver side in wireless communication. The signal that is received by the wireless receiver in FIG. 4B may correspond to the signal output by the wireless receiver in FIG. 4A. In FIG. 4B, the received signal may go through a demodulation processing 452, which may extract the amplitude, phase, or frequency changes applied to the carrier wave during the modulation process at the transmitter side. The demodulation techniques may include Quadrature Amplitude Demodulation, Phase Shift Keying (PSK) demodulation, and Frequency Shift Keying (FSK) demodulation. After the demodulation process, the received signal may go through a decoder 454, such as an FEC decoder, and a de-shaping process 456 to extract the information bits 458. The decoder 454 may correct errors in the received signal, which might be introduced by noise or interference during the transmission. The de-shaping process 456 is the reverse of the shaping process 406 applied at the transmitter side. The wireless receiver at the receiver side may reverse the shaping procedure and recover the raw and unshaped information bits.

The probability of an information bit being a 0 may be approximately the same as that of a 1. Hence, each phase, frequency, and amplitude state (i.e., each constellation point) may have the same probability of being used.

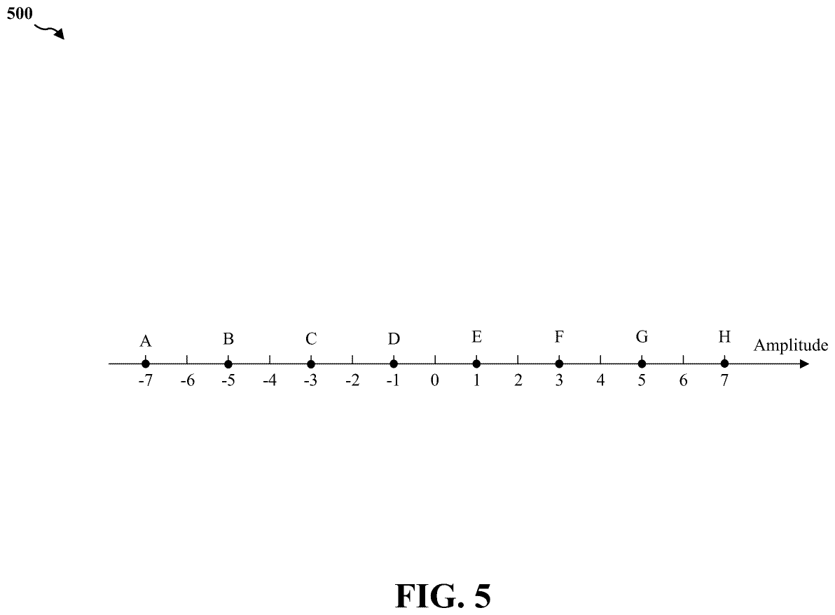

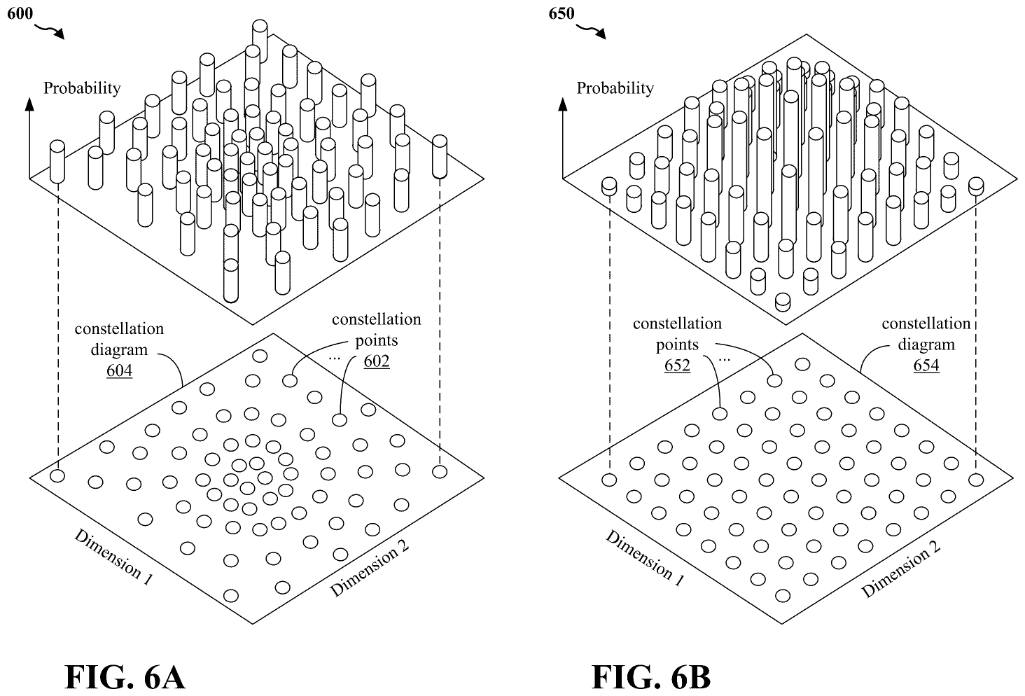

The constellation points may have different amplitudes. FIG. 5 is a diagram 500 illustrating example constellation points with different amplitudes. In the examples shown in FIG. 5, the constellation points A to H have different amplitudes, ranging from −7 to 7. A symbol corresponding to a constellation point with a higher amplitude may use more power to be transmitted than a symbol corresponding to a constellation point with a lower amplitude. For example, in FIG. 5, the symbol corresponding to constellation point A (which has an amplitude of −7) may use more transmission power than the symbol corresponding to constellation point E (which has an amplitude of 1). The symbol distribution may be adjusted to improve the efficiency of the transmission. For example, the symbol distribution may be adjusted so that the symbols corresponding to constellation points with lower amplitude are used more often than those corresponding to the constellation points with higher amplitude. The symbol distribution may be adjusted through geometric shaping or probabilistic shaping. FIG. 6A is a diagram 600 illustrating an example of geometric shaping. In FIG. 6A, the distribution of constellation points 602 in the constellation diagram 604 may be adjusted so that the constellation points 602 become more concentrated in some regions of the constellation diagram 604 than other regions, while the probability of each of the constellation points 602 being used (represented by the heights of the cylinders) may remain approximately the same. FIG. 6B is a diagram 650 illustrating an example of probabilistic shaping. In FIG. 6B, the constellation points 652 in the constellation diagram 654 may remain uniformly distributed (e.g., adjacent constellation points on the constellation diagram 654 may form a square (a square QAM) or be equidistant from each other), while the probability of each of the constellation points 652 being used (represented by the heights of the cylinders) may be adjusted so that some constellation points 652 may have a higher probability of being used than others.

Probabilistic shaping (PS) may generate non-uniformly distributed Quadrature Amplitude Modulation (QAM) constellations with the objective of maximizing the mutual information (I(X;Y)) between transmitted and received signals. As used herein, I(X;Y) refers to the mutual information between the transmitted signal X and received signal Y. In some examples, mutual information I(X;Y) may be calculated by: I(X;Y)=H(X)−H(X|Y), where H(X) is the entropy of X, and H(X|Y) is the conditional entropy of X given Y. The higher the mutual information between X and Y, the more reliable the transmission is for a fixed communication rate. Equivalently, for the same error rate (reliability) target, the larger the mutual information, the higher the achievable rate can be.

Probabilistic shaping may be viewed as an “inverse source coding” process. In source coding, a non-uniform source is compressed into uniformly distributed bits, whereas in probabilistic shaping, uniform bits are converted into non-uniformly distributed, “Gaussian-like” bits or amplitudes. This conversion allows for more efficient communication and improved performance in the presence of noise.

In some examples, the probabilistic shaping may be based on the Maxwell-Boltzmann distribution, which may be defined as p(x)˜e^{-v|x|}^{²}. This distribution maximizes the source entropy for a given average power, and inner constellations may be used with higher probability than the outer constellations. As used herein, a “constellation,” or “constellation point,” refers to a point in the constellation diagram that represents a particular symbol or value in a modulation scheme. Each symbol or value is associated with a specific amplitude and phase of the modulated signal.

A popular technique for probabilistic shaping is Probabilistic Amplitude Shaping (PAS), which shapes the amplitude of the constellation, but leaving the sign of the constellation uniformly distributed. Studied related to the PAS generally aimed to close the 1.53 dB shaping gap towards log (1+SNR) over the Additive White Gaussian Noise (AWGN) channel.

The PAS may include a distribution matcher that maps a bit sequence, in which each bit in the bit sequence has approximately the same probability of being 1 or 0, to a symbol sequence, in which the symbols in the symbol sequence have the desired distribution (e.g., a Maxwell-Boltzmann distribution approximates a Gaussian distribution). Each of the symbol sequences may have the same length (i.e., the symbol block length).

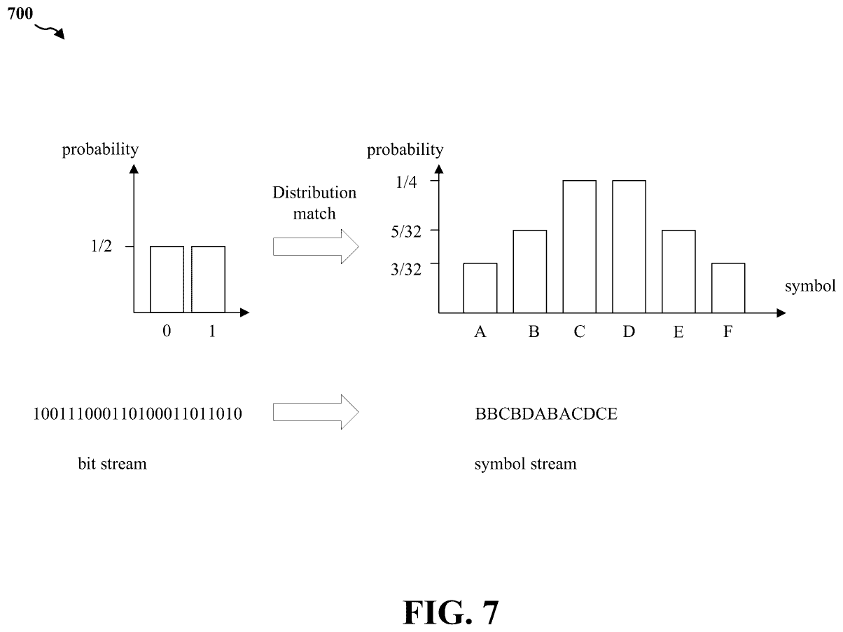

Table 2 shows an example bit-to-symbol mapping of the PAS that maps a bit sequence to a symbol sequence. In the example shown in Table 2, a four-bit sequence may be mapped to a two-symbol sequence. For example, the bit sequence of “0101” may be mapped to the symbol sequence of “DC.” The number of bits of each bit sequence (in this case, four) may be referred to as the “bit length.” The mapping relationship between the bit sequences and the symbol sequences may be chosen so that the symbols used in the transmission have a desired symbol distribution, such as a Gaussian distribution. FIG. 7 is a diagram 700 illustrating the bit-to-symbol mapping corresponding to Table 2. In the example shown in FIG. 7, each bit in the bit sequence may have an approximately equal probability (i.e., 1/2 probability) of being either a “0” or a “1.” By choosing a mapping relationship between the bit sequences and the symbol sequences, the symbols may distribute following a Gaussian distribution, and some symbols (e.g., symbols “C” and “D”) may have a higher probability of being used in the symbol sequence than other symbols (e.g., symbols “A” and “F”).

TABLE 2
Example bit-to-symbol mapping

| Number | Bit sequence | Symbol sequence |
|---|---|---|
| 0 | 0000 | EF |
| 1 | 0001 | EE |
| 2 | 0011 | DF |
| 3 | 0010 | DE |
| 4 | 0110 | DA |
| 5 | 0100 | DB |
| 6 | 0101 | DC |
| 7 | 0111 | DD |
| 8 | 1111 | CC |
| 9 | 1101 | CD |
| 10 | 1100 | CB |
| 11 | 1110 | CA |
| 12 | 1010 | CE |
| 13 | 1011 | CF |
| 14 | 1001 | BB |
| 15 | 1000 | BA |

The present invention addresses the challenge of integrating probabilistic shaping into communication systems, such as a 5G NR communication system, 6G communication system, or other wireless communication system, with minimal hardware and software changes or implementation cost. The transmission flow in a communication system can be more complex than is apparent from a high-level transmitter and receiver flow.

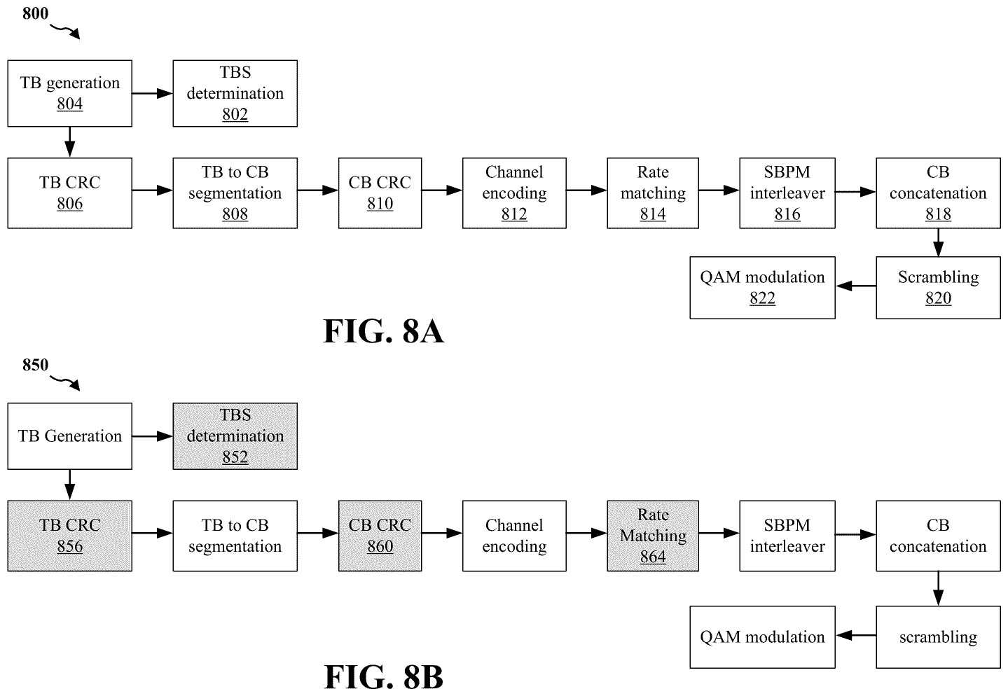

FIG. 8A is a diagram 800 illustrating various aspects in a data flow. In some aspects, the data flow may correspond to a 5G NR data flow. In FIG. 8A, the data flow may include TB size (TBS) determination 802, TB generation 804, TB CRC insertion 806, TB to CB segmentation 808, CB CRC insertion 810, channel encoding 812, rate matching 814, systematic bit priority mapping (SBPM) interleaving 816, CB concatenation 818, data scrambling 820, and QAM modulation 822. For a 5G NR communication system, the channel encoding 812 may be Low-Density Parity-Check (LDPC) encoding.

Example aspects of the present disclosure help to identify and modify the components within the transmission flow to support probabilistic shaping while maintaining compatibility with wireless communication systems, such as maintaining compatibility with a 5G NR communication system. Additionally, example aspects of the present disclosure also aim to maximize the hardware reusability between 5G and 6G communication systems. This approach enables better coexistence between different RATs, such as coexistence between 5G and 6G networks and simplifies the implementation of multi-mode modems, which are designed to support multiple RATs, such as supporting both 5G and 6G communication standards. In order to support probabilistic shaping and coexistence between different RATs, example aspects provide modifications to blocks within the transmission flow, that minimizes hardware and software changes while effectively integrating probabilistic shaping. FIG. 8B is a diagram 850 illustrating various aspects affected by probabilistic shaping in accordance with the present disclosure. As shown in FIG. 8B, these aspects may include TBS determination 852, TB CRC insertion 856, CB CRC insertion 860, and rate matching 864.

Example aspects presented herein first provide a method for determining the TBS in wireless communication employing probabilistic shaping.

Aspects may include calculating the number of bits consumed by FEC after shaping, denoted as K_{FEC}^{TB}. This may be achieved using the same formula as in the NR standard, with modifications to account for the possible changes in the CRC length(s).

Aspects may also include determining the number of data bits serviced for the medium access control (MAC) layer based on K_{FEC}^{TB} and the shaping rate. In some aspects, the number of data bits serviced for the MAC layer may be the conventional TB size used in 5G or earlier systems, denoted as K^{TB}. The core concept of some example aspects may include computing the TB size through a two-step process. The first step may involve calculating an intermediate size based on the FEC coding rate, modulation order, and resource allocation. Subsequently, the second step may involve determining the actual TB size based on the intermediate size and the shaping rate, among other parameters. The approach to determine of the number of data bits serviced for the MAC layer may include various considerations.

As a first example, the determination may include determining the number of CBS, denoted as n_{CB}, the uncoded CB size K_{FEC}^{TB} consumed by FEC, and the coded CB size N_{FEC}^{CB} after rate matching. For example, K_{FEC}^{TB}=K_{FEC}^{CB}·n_{CB}±n_{CRC}. As an example, for NR, the uncoded CB size may be the same across all CBs in the same TB, but the coded CB size may vary across different CBs (with two possible values). In the example aspects provided herein, the coded CB size N_{FEC}^{CB} may be chosen to be either the larger or smaller value, depending on the rate matching schemes used.

The determination may include determining the number of information bits per CB, represented as K_{info}, and K_{info}=Kₛₕₐₚₑ+Kₙₒₙₛₕₐₚₑ, where Kₛₕₐₚₑ represents the number of information bits to be shaped, and Kₙₒₙₛₕₐₚₑ represents the number of information bits that are not shaped. Kₙₒₙₛₕₐₚₑ includes uniformly distributed bits in the transmission and punctured information bits from the channel code. The relationship between Kₛₕₐₚₑ, Kₙₒₙₛₕₐₚₑ, and K_{FEC}^{CB} may be expressed as

$$\frac{{K}_{shape}}{{R}_{shape}} + {K}_{nonshape} = {K}_{FEC}^{CB} ,$$

where Rₛₕₐₚₑ is the shaping rate. In some examples, for a shaping function that accepts an input of K bits and generates an output of N bits, the shaping rate may be defined as the ratio of input bits (K) to output bits (N), represented as: Rₛₕₐₚₑ=K/N.

Example aspects presented herein provide methods for CRC insertion for probabilistic-shaped systems. The TB CRC may be inserted in various different options.

In a first example option, the TB CRC may be inserted prior to the probabilistic shaping. This approach offers the advantage of allowing the receiver to detect whether the de-shaping process has been performed correctly after de-shaping.

In a second example option, the TB CRC may be inserted after the probabilistic shaping. This alternative benefits from enabling the decoding hardware to be largely leveraged between uniform QAM and probabilistic shaping, thereby simplifying the system design.

A third example option may combine the previous two options by adding one TB CRC (the first TB CRC) before the probabilistic shaping and another TB CRC (the second TB CRC) after the probabilistic shaping. This approach provides a comprehensive CRC insertion method that ensures accurate de-shaping and efficient hardware utilization.

Additionally, the code block (CB) CRC may be inserted after the probabilistic shaping. This guarantees that the CB CRC can be employed for early termination in decoding for the channel decoder. This method also allows for a simple, unified implementation of TB-to-CB segmentation for both shaping and non-shaping configurations.

By adopting one or more of these innovative CRC insertion options, these methods enhance the reliability and efficiency of communication systems employing probabilistic shaping, while maintaining compatibility with existing hardware and simplifying system design.

Example aspects presented herein provide example aspects for applying the probabilistic shaping in wireless communication.

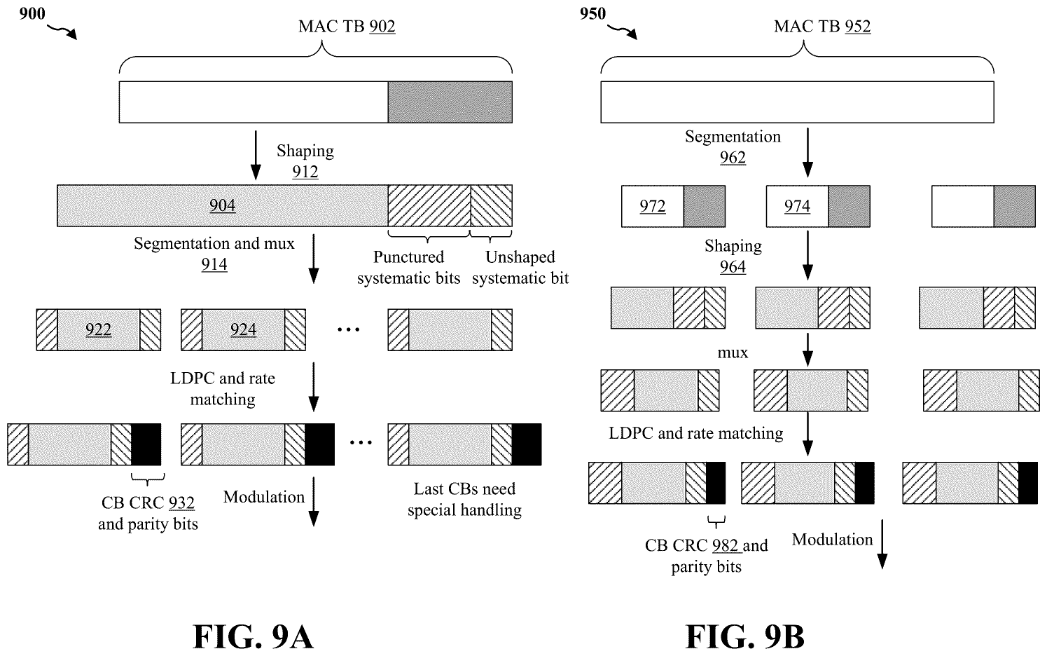

A first example aspect may include applying the probabilistic shaping jointly on the TB level and across different CBs. This aspect enables efficient shaping across the entire TB, considering the relationships between CBs and potentially enhancing the overall performance of the communication system. FIG. 9A is a diagram 900 illustrating an example of TB-level shaping in accordance with various aspects of the present disclosure. In FIG. 9A, the MAC TB 902 may first go through a shaping process 912, and the shaped data block (e.g., block 904) may go through the segmentation (e.g., the TB-to-CB segmentation) and muxing process 914 to be segmented into multiple individual data blocks (e.g., blocks 922, 924). These blocks may further go through the LDPC and rate matching, and modulation process. In some aspects, the CB CRC 932 and parity bits may be inserted into the data block (e.g., blocks 922, 924) after the LDPC and rate matching process.

A second example aspect may include applying the probabilistic shaping separately within each CB. This approach simplifies the implementation of shaping by treating each CB as an independent unit, allowing for easier integration into existing communication systems. FIG. 9B is a diagram 950 illustrating an example of CB-level shaping in accordance with various aspects of the present disclosure. In FIG. 9B, the MAC TB 952 may first go through a segmentation process 962 to be segmented into multiple data blocks (e.g., blocks 972, 974), and the shaping process 964 may be applied on each of the segmented data blocks (e.g., blocks 972, 974). After the shaping process 964, each of the data blocks may further go through the muxing (i.e., multiplexing) process, the LDPC and rate matching, and the modulation process. In some aspects, the CB CRC 982 and parity bits may be inserted into the data block (e.g., blocks 972, 974) after the LDPC and rate matching process.

Example aspects presented herein further address the segmentation of data bits for probabilistic shaping in wireless communication. By employing block-based shaping, a large set of data bits may be divided into smaller blocks, with shaping applied separately to each block. This approach enables improved pipelining for shaping and de-shaping operations, as multiple blocks of bits can be processed simultaneously using the same hardware, effectively reducing latency and increasing throughput. In some aspects, regardless of whether TB-level or CB-level shaping is utilized, the number of bits to be shaped may be selected as an integer multiple of the number of blocks for probabilistic shaping. This ensures that the same shaping configuration may be applied to all shaping blocks (SBs), providing consistency across the entire transmission. For example, if there are 10,000 bits to be shaped, they may be divided into 10 shaping blocks, with each block containing 1,000 bits. The shaping operation is then performed on each of the 1,000-bit blocks using the same shaping scheme or configuration.

In some wireless communication systems, such as LTE and NR systems, the number of REs allocated for a transmission may not be integer multiples of the number of CBs. In such cases, the CBs may have the same information size, but their sizes may differ after channel coding and rate matching. This approach has the advantage of using the same channel code (e.g., the same LDPC base graph, the same lifting size, etc.) across the CBs for better encoder/decoder pipelining, with the difference being the rate matching. However, some CBs may occupy fewer REs than others, resulting in more parity bits being punctured for these CBs. For example, with the number of REs for the larger CB being n_{RE}^{CB}, the number of REs for the smaller CB(s) may be, n_{RE}^{CB}−1. This can be problematic for probabilistic shaping, as the number of information bits used for the shaping block may depend on the number of modulation symbols or REs contained in each CB.

Example aspects presented herein provide a method that addresses this issue by using the same channel code and coded CB size across all CBs, offering multiple, e.g., two, options for rate matching. In a first aspect, the coded CB size may be determined based on the code size of the larger REs (n_{RE}^{CB}) and, for the smaller CBs, both systematic bits and parity bits may be punctured to maintain the shaping on the modulation symbols. For example, if the number of systematic bits serviced by the FEC is L×(m−2)n_{RE}^{CB}, where m is the modulation order and L is the number of layers associated with the CB, L×(m−2) bits systematic bits may be punctured so that the remaining systematic bits map to the amplitude of the L×(n_{RE}^{CB}−1) modulation symbols.

In a second aspect, the coded CB size may be determined based on the code size of the smaller CB (n_{RE}^{CB}−1), and, for larger CBs, an additional unshaped modulation symbol containing all parity bits (e.g., L×m additional parity bits compared to the smaller CBs) may be transmitted on the last RE. This approach ensures consistent channel code and coded CB size across all CBs while offering flexibility in rate matching to accommodate different CB sizes and maintain probabilistic shaping performance.

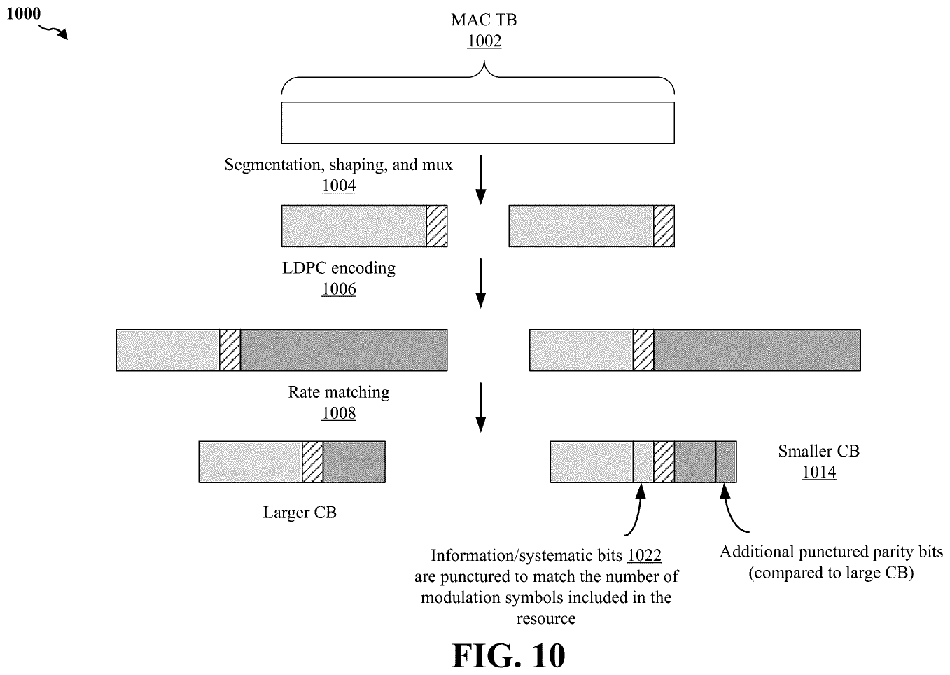

FIG. 10 is a diagram 1000 illustrating an example of a rate matching process using the same channel code and coded CB size in accordance with various aspects of the present disclosure. In FIG. 10, the MAC TB 1002 may go through the segmentation (e.g., TB-to-CB segmentation), shaping and muxing process 1004, the LDPC encoding 1006, and the rate matching process 1008. The TB-to-CB segmentation may produce a set of CBs with two distinct sizes: the first subset of CBs may have a smaller size, while the remaining CBs may have a larger size. In the rate matching process 1008, the coded CB size determined based on the larger CB or the smaller CB may be used. If the coded CB size based on the larger CB is used, both systematic bits 1022 and parity bits may be punctured for the smaller CB 1014 to maintain the shaping on the modulation symbols. If the coded CB size based on the smaller CB is used, an additional modulation symbol containing all parity bits may be transmitted on the last RE in each of the larger CBs.

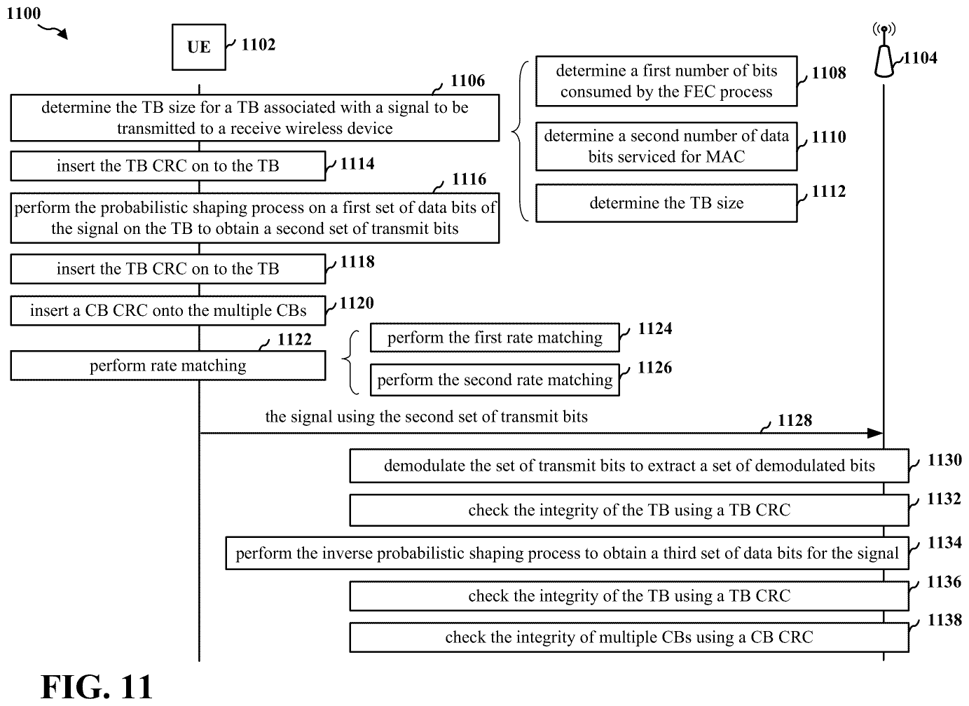

FIG. 11 is a call flow diagram 1100 illustrating a method of wireless communication in accordance with various aspects of this present disclosure. Example aspects are described in connection with a transmitting wireless device and a receiving wireless device. In some examples, the UE 1102 may be used as an example of the transmitting wireless device, and the base station 1104 may be used as an example of the receiving wireless device. Various aspects in the diagram 1100 may be performed by a UE or a base station in aggregation and/or by one or more components of a base station 1104 (e.g., such as a CU 110, a DU 130, and/or an RU 140). It should be noted that this is not an exhaustive list and other wireless devices can be used in place of the UE 1102 and the base station 1104, respectively.

In FIG. 11, a UE 1102 may, at 1106, determine the TB size associated with a signal to be transmitted to the receiving wireless device. In some aspects, the receiving wireless device may be base station 1104. In some aspects, the TB size may be determined based at least in part on a first parameter associated with the FEC process and a second parameter associated with a probabilistic shaping process.

In some aspects, to determine the TB size, the UE 1102 may, at 1108, determine a first number of bits consumed by the FEC process based at least in part on the first parameter. Then, the UE 1102 may, at 1110, determine a second number of data bits serviced for MAC based on the first number of bits and a shaping rate, and, at 1112, determine the TB size based on the second number of data bits.

In some aspects, at 1114, the UE 1102 may insert the TB CRC onto the TB prior to the probabilistic shaping process.

At 1116, the UE 1102 may perform the probabilistic shaping process on the first set of data bits of the signal on the TB to obtain a second set of transmit bits. In some aspects, the TB CRC may be inserted into the TB before or after the probabilistic shaping process, and the probabilistic shaping process may be applied on the TB level across multiple CBs associated with the TB or on the CB level individually inside each CB of the multiple CBs. For example, referring to FIG. 9A, the probabilistic shaping process 912 may be applied on the TB level (on TB 902). Referring to FIG. 9B, the probabilistic shaping process 964 may be applied on the CB level (on blocks 972, 974 individually).

At 1118, the UE 1102 may insert the TB CRC onto the TB after the probabilistic shaping process (at 1116).

In some aspects, the UE 1102 may insert, at 1114, a first TB CRC onto the TB prior to the probabilistic shaping process (at 1116), and insert, at 1118, a second TB CRC onto the TB after the probabilistic shaping process (at 1116).

At 1120, the UE 1102 may insert a CB CRC onto the multiple CBs after the probabilistic shaping process (at 1116). For example, referring to FIG. 9A, the CB CRC 932 may be inserted after the probabilistic shaping process 912. Referring to FIG. 9B, the CB CRC 982 may be inserted after the probabilistic shaping process 964.

At 1122, the UE 1102 may perform rate matching. In some aspects, to perform the rate matching, the UE 1102 may, at 1124, perform a first rate matching. The first matching may be performed using the same channel code and the same coded CB size for all the CBs of the multiple CBs. Then, the UE 1102 may, at 1126, perform a second rate matching. The second rate matching may be performed on a subset of CBs from the multiple CBs by adding or removing one or more modulation symbols associated with the subset of CBs. For example, referring to FIG. 10, when performing the rate matching process 1008, the first matching may be performed using the same channel code and the same coded CB size for all the CBs of the multiple CBs. Then, depending on the coded CB size used, a second process may be performed on a subset of CBs from the multiple CBs. The second process may include adding one or more modulation symbols (e.g., systematic bits 1022 and parity bits) or removing one or more modulation symbols associated with the subset of CBs.

At 1128, the UE 1102 may transmit, to the base station 1104, the signal using the second set of transmit bits.

At 1130, upon receiving the set of transmit bits (at 1128.) the base station 1104 may demodulate the set of transmit bits to extract a set of demodulated bits.

At 1132, the base station 1104 may check, before performing the inverse probabilistic shaping process, the integrity of the TB using a TB CRC inserted (at 1118) after a probabilistic shaping process (at 1116) at the transmitting wireless device.

At 1134, the base station 1104 may perform, based on the set of demodulated bits and a TB associated with the set of demodulated bits, an inverse probabilistic shaping process to obtain a set of data bits for the signal.

At 1136, the base station 1104 may check, after performing the inverse probabilistic shaping process (at 1134), the integrity of the TB using a TB CRC inserted (at 1114) prior to a probabilistic shaping process (at 1116) at the transmitting wireless device.

In some aspects, the base station 1104 may check, before performing the inverse probabilistic shaping process (at 1134), the integrity of the TB using the first TB CRC inserted (at 1114) prior to the probabilistic shaping process (at 1116) at the transmitting wireless device, and check, after performing the inverse probabilistic shaping process (at 1134), the integrity of the TB using a second TB CRC inserted (at 1118) after the probabilistic shaping process (at 1116) at the transmitting wireless device.

At 1138, the base station 1104 may check the integrity of multiple CBs associated with the TB using a CB CRC inserted (at 1120) after the probabilistic shaping process (at 1116) at the transmitting wireless device.

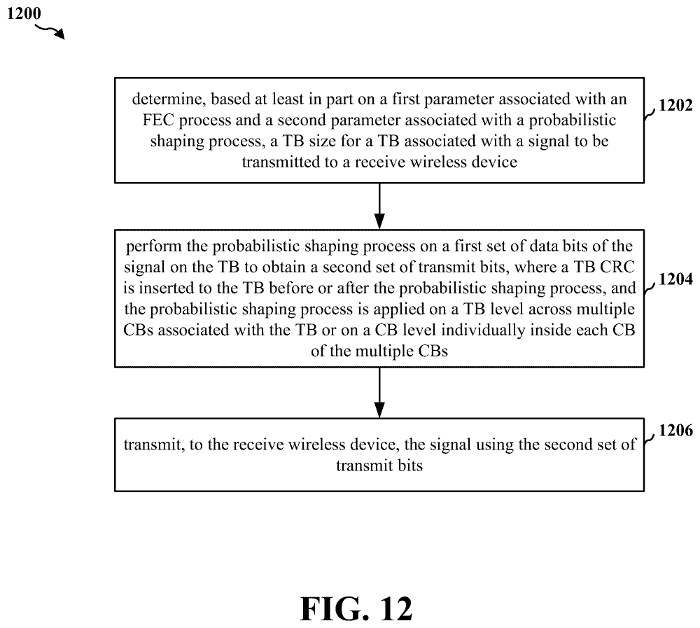

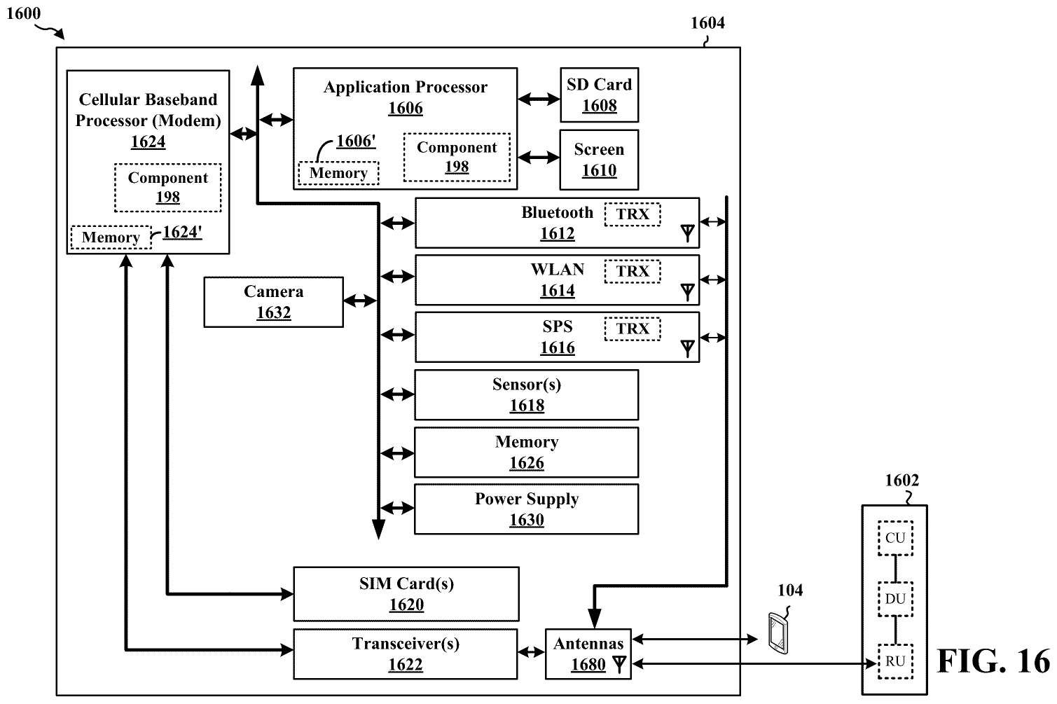

FIG. 12 is a flowchart 1200 illustrating methods of wireless communication at a transmitting wireless device in accordance with various aspects of the present disclosure. The method may be performed by the transmitting wireless device. In some aspects, the transmitting wireless device may be a UE. The UE may be the UE 104, 350, 1102, or the apparatus 1604 in the hardware implementation of FIG. 16. The method provides flexible and adaptive integration of the probabilistic shaping process, including various options for CRC insertion, rate matching, and segmentation for probabilistic shaping, into existing and new communication systems. The method improves the efficiency, throughput, and latency of wireless communication.

In FIG. 12, at 1202, the UE may determine, based at least in part on a first parameter associated with an FEC process and a second parameter associated with a probabilistic shaping process, a TB size for a TB associated with a signal to be transmitted to a receiving wireless device. In some aspects, the receiving wireless device may be a network entity, which may be a base station, or a component of a base station, in the access network of FIG. 1 or a core network component (e.g., base station 102, 310, 1104; or the network entity 1602 in the hardware implementation of FIG. 16). FIGS. 9A, 9B, 10, and 11 illustrate various aspects in connection with flowchart 1200. For example, referring to FIG. 11, the UE 1102 may determine, at 1106, based at least in part on a first parameter associated with an FEC process and a second parameter associated with a probabilistic shaping process, a TB size for a TB associated with a signal to be transmitted to a receiving wireless device. In some aspects, 1202 may be performed by the probabilistic shaping component 198.

At 1204, the UE may perform the probabilistic shaping process on a first set of data bits of the signal on the TB to obtain a second set of transmit bits. The TB CRC may be inserted into the TB before or after the probabilistic shaping process, and the probabilistic shaping process may be applied on the TB level across multiple CBs associated with the TB or on the CB level individually inside each CB of the multiple CBs. For example, referring to FIG. 11, the UE 1102 may perform, at 1116, the probabilistic shaping process on a first set of data bits of the signal on the TB to obtain a second set of transmit bits. The TB CRC may be inserted into the TB before (at 1114) or after (at 1118) the probabilistic shaping process (at 1116). Referring to FIG. 9A, the probabilistic shaping process 912 may be applied on the TB level across multiple CBs associated with the TB 902. Referring to FIG. 9B, the probabilistic shaping process 964 may be applied on the CB level individually inside each CB of the multiple CBs (e.g., blocks 972, 974). In some aspects, 1204 may be performed by the probabilistic shaping component 198.

At 1206, the UE may transmit, to the receiving wireless device, the signal using the second set of transmit bits. For example, referring to FIG. 11, the UE 1102 may transmit, at 1128, to the receiving wireless device (base station 1104), the signal using the second set of transmit bits. In some aspects, 1206 may be performed by the probabilistic shaping component 198.

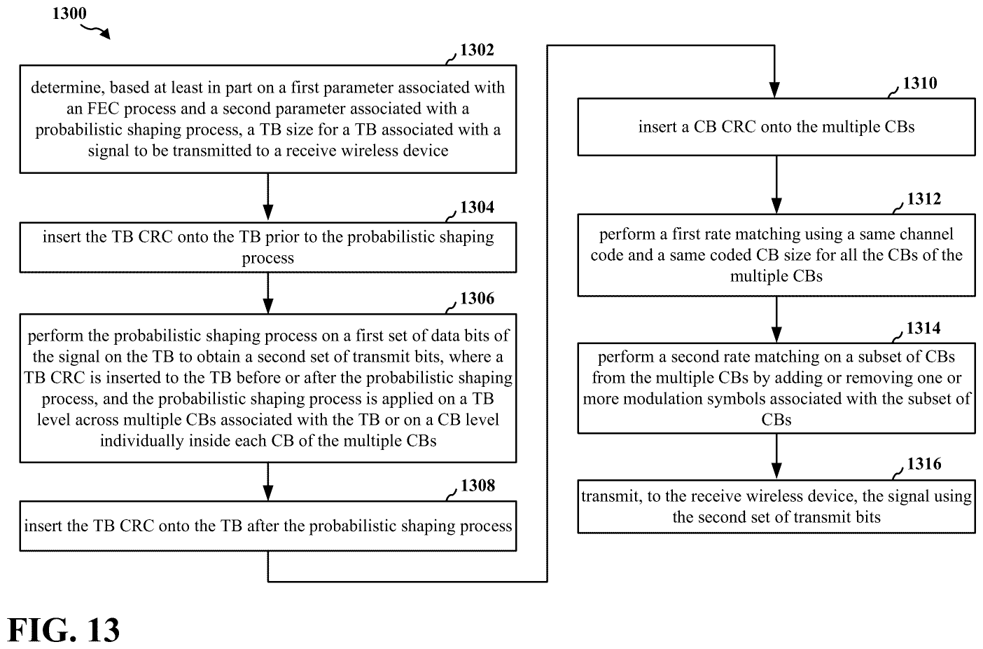

FIG. 13 is a flowchart 1300 illustrating methods of wireless communication at a transmitting wireless device in accordance with various aspects of the present disclosure. The method may be performed by the transmitting wireless device. In some aspects, the transmitting wireless device may be a UE. The UE may be the UE 104, 350, 1102, or the apparatus 1604 in the hardware implementation of FIG. 16. The method provides flexible and adaptive integration of the probabilistic shaping process, including various options for CRC insertion, rate matching, and segmentation for probabilistic shaping, into existing and new communication systems. The method improves the efficiency, throughput, and latency of wireless communication.

In FIG. 13, at 1302, the UE may determine, based at least in part on a first parameter associated with an FEC process and a second parameter associated with a probabilistic shaping process, a TB size for a TB associated with a signal to be transmitted to a receiving wireless device. In some aspects, the receiving wireless device may be a network entity, which may be a base station, or a component of a base station, in the access network of FIG. 1 or a core network component (e.g., base station 102, 310, 1104; or the network entity 1602 in the hardware implementation of FIG. 16). FIGS. 9A, 9B. 10, and 11 illustrate various aspects in connection with flowchart 1300. For example, referring to FIG. 11, the UE 1102 may determine, at 1106, based at least in part on a first parameter associated with an FEC process and a second parameter associated with a probabilistic shaping process, a TB size for a TB associated with a signal to be transmitted to a receiving wireless device. In some aspects, 1302 may be performed by the probabilistic shaping component 198.

At 1306, the UE may perform the probabilistic shaping process on a first set of data bits of the signal on the TB to obtain a second set of transmit bits. The TB CRC may be inserted into the TB before or after the probabilistic shaping process, and the probabilistic shaping process may be applied on the TB level across multiple CBs associated with the TB or on the CB level individually inside each CB of the multiple CBs. For example, referring to FIG. 11, the UE 1102 may perform, at 1116, the probabilistic shaping process on a first set of data bits of the signal on the TB to obtain a second set of transmit bits. The TB CRC may be inserted into the TB before (at 1114) or after (at 1118) the probabilistic shaping process (at 1116). Referring to FIG. 9A, the probabilistic shaping process (912) may be applied on the TB level across multiple CBs associated with the TB 902. Referring to FIG. 9B, the probabilistic shaping process 964 may be applied on the CB level individually inside each CB of the multiple CBs (e.g., blocks 972, 974). In some aspects, 1306 may be performed by the probabilistic shaping component 198.

At 1316, the UE may transmit, to the receiving wireless device, the signal using the second set of transmit bits. For example, referring to FIG. 11, the UE 1102 may transmit, at 1128, to the receiving wireless device (base station 1104), the signal using the second set of transmit bits. In some aspects, 1316 may be performed by the probabilistic shaping component 198.

In some aspects, to determine the TB size, the UE may be configured to determine a first number of bits consumed by the FEC process based at least in part on the first parameter, and determine, based at least in part on the first number of bits, the TB size. For example, referring to FIG. 11, to determine the TB size (at 1106), the UE 1102 may be configured to determine, at 1108, a first number of bits consumed by the FEC process based at least in part on the first parameter, and determine, at 1112, based at least in part on the first number of bits, the TB size.

In some aspects, to determine, based at least in part on the first number of bits, the TB size, the UE may be configured to: determine a second number of data bits serviced for MAC based on the first number of bits and a shaping rate; and determine the TB size based on the second number of data bits. For example, referring to FIG. 11, the UE may be configured to: determine, at 1110, a second number of data bits serviced for MAC based on the first number of bits and a shaping rate; and determine, at 1112, the TB size based on the second number of data bits.

In some aspects, to determine the second number of data bits, the UE may be configured to: determine a third number of CBs associated with the first number of bits, an unencoded CB size before coding, and a coded CB size after coding; determine a fourth number of information bits per CB based on a shaped number of information bits to be shaped and an unshaped number of information bits that are not shaped; and determine the second number of data bits based on the fourth number of information bits. For example, referring to FIG. 11, when determining the second number of data bits at 1110, the UE 1102 may be configured to: determine a third number of CBs associated with the first number of bits, an unencoded CB size before coding, and a coded CB size after coding; determine a fourth number of information bits per CB based on a shaped number of information bits to be shaped and an unshaped number of information bits that are not shaped; and determine the second number of data bits based on the fourth number of information bits.

In some aspects, to determine the fourth number of information bits per CB, the UE may be configured to: determine the fourth number of information bits per CB using a same coded CB size for all the CBs of the multiple CBs. For example, referring to FIG. 11, when the UE 1102 determines the second number of data bits serviced for MAC, the UE 1102 may use the same coded CB size for all the CBs.

In some aspects, to perform the probabilistic shaping process (at 1306), the UE may be configured to: perform the probabilistic shaping process using a same coded CB size for all the CBs of the multiple CBs. For example, referring to FIG. 11, when the UE 1102 performs the probabilistic shaping process (at 1116), the UE 1102 may perform the probabilistic shaping process (at 1116) using the same coded CB size for all the CBs of the multiple CBs.

In some aspects, at 1312, the UE may perform a first rate matching using the same channel code and the same coded CB size for all the CBs of the multiple CBs. At 1314, the UE may perform a second rate matching on a subset of CBs from the multiple CBs by adding or removing one or more modulation symbols associated with the subset of CBs. For example, referring to FIG. 11, the UE 1102 may perform, at 1124, the first rate matching using the same channel code and the same coded CB size for all the CBs of the multiple CBs, and perform, at 1126, a second rate matching on a subset of CBs from the multiple CBs by adding or removing one or more modulation symbols associated with the subset of CBs. Referring to FIG. 10, when performing the rate matching process 1008, the first matching may be performed using the same channel code and the same coded CB size for all the CBs of the multiple CBs. Then, depending on the coded CB size used, a second process may be performed on a subset of CBs from the multiple CBs. The second process may include adding one or more modulation symbols (e.g., systematic bits 1022 and parity bits) or removing one or more modulation symbols associated with the subset of CBs. In some aspects, 1312 and 1314 may be performed by the probabilistic shaping component 198.

In some aspects, to perform the second rate matching on the subset of CBs (at 1314), the UE may be configured to: perform the second rate matching by removing the one or more modulation symbols associated with the subset of CBs. To remove the one or more modulation symbols, the UE may be configured to: remove one or more systematic bits associated with one or more removed modulation symbols. For example, referring to FIG. 11, when performing the second rate matching, at 1126, on the subset of CBs, the UE 1102 may remove the one or more modulation symbols associated with the subset of CBs. To remove the one or more modulation symbols, the UE 1102 may remove one or more systematic bits associated with one or more removed modulation symbols.

In some aspects, the coded CB size may be the largest number of REs that one CB of the multiple CBs occupies, and the system bits and the parity bits may be removed for the CBs occupying a second number of REs less than the largest number. For example, referring to FIG. 11, when performing the first rate matching at 1124, the coded CB size may be the largest number of REs that one CB of the multiple CBs occupies, and, at the second rate matching, at 1126, the system bits and the parity bits may be removed for the CBs occupying a second number of REs less than the largest number.

In some aspects, the coded CB size may be the smallest number of REs that one CB of the multiple CBs occupies, and the additional modulation symbol containing all parity bits may be transmitted on the CBs occupying a third number of REs larger that the smallest number. For example, referring to FIG. 11, when performing the first rate matching at 1124, the coded CB size may be the smallest number of REs that one CB of the multiple CBs occupies, and, at the second rate matching, at 1126, the additional modulation symbol containing all parity bits may be transmitted on the CBs occupying a third number of REs larger that the smallest number.

In some aspects, at 1304, the UE may insert the TB CRC onto the TB prior to the probabilistic shaping process (at 1306). For example, referring to FIG. 11, the UE 1102 may, at 1114, insert the TB CRC onto the TB prior to the probabilistic shaping process (at 1116). In some aspects, 1304 may be performed by the probabilistic shaping component 198.

In some aspects, at 1308, the UE may insert the TB CRC onto the TB after the probabilistic shaping process (at 1306). For example, referring to FIG. 11, the UE 1102 may insert, at 1118, the TB CRC onto the TB after the probabilistic shaping process (at 1116). In some aspects, 1308 may be performed by the probabilistic shaping component 198.

In some aspects, the UE may insert, at 1304, a first TB CRC onto the TB prior to the probabilistic shaping process (at 1306), and insert, at 1308, a second TB CRC onto the TB after the probabilistic shaping process (at 1306). For example, referring to FIG. 11, the UE 1102 may insert, at 1114, a first TB CRC onto the TB prior to the probabilistic shaping process (at 1116), and insert, at 1118, a second TB CRC onto the TB after the probabilistic shaping process (at 1116).

In some aspects, at 1310, the UE may insert a CB CRC onto the multiple CBs after the probabilistic shaping process (at 1306). For example, referring to FIG. 11, the UE 1102 may insert, at 1120, a CB CRC onto the multiple CBs after the probabilistic shaping process (at 1116). Referring to FIG. 9A, a CB CRC 932 may be inserted onto the multiple CBs after the probabilistic shaping process (at 912). In some aspects, 1310 may be performed by the probabilistic shaping component 198.

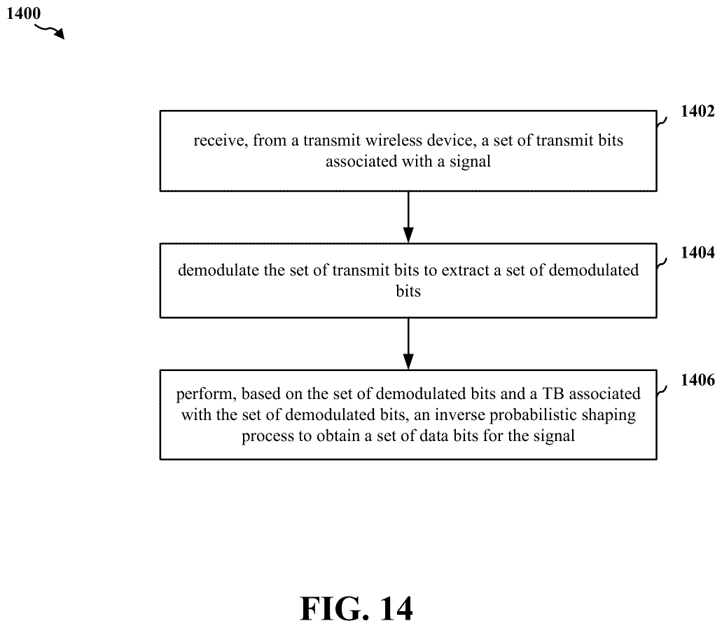

FIG. 14 is a flowchart 1400 illustrating methods of wireless communication at a receiving wireless device in accordance with various aspects of the present disclosure. The method may be performed by the receiving wireless device. In some aspects, the receiving wireless device may be a network entity, which may be a base station, or a component of a base station, in the access network of FIG. 1 or a core network component (e.g., base station 102, 310, 1104; or the network entity 1602 in the hardware implementation of FIG. 16). The method provides flexible and adaptive integration of the probabilistic shaping process, including various options for CRC insertion, rate matching, and segmentation for probabilistic shaping, into existing and new communication systems. The method improves the efficiency, throughput, and latency of wireless communication.

In FIG. 14, at 1402, the network entity may receive, from a transmitting wireless device, a set of transmit bits associated with a signal. In some aspects, the transmitting wireless device may be a UE. The UE may be the UE 104, 350, 1102, or the apparatus 1604 in the hardware implementation of FIG. 16. FIGS. 9A, 9B, 10, and 11 illustrate various aspects in connection with flowchart 1400. For example, referring to FIG. 11, the network entity (base station 1104) may receive, at 1128, from a transmitting wireless device (UE 1102), a set of transmit bits associated with a signal. In some aspects, 1402 may be performed by the probabilistic shaping component 199.

At 1404, the network entity may demodulate the set of transmit bits to extract a set of demodulated bits. For example, referring to FIG. 11, the network entity (base station 1104) may demodulate, at 1130, the set of transmit bits to extract a set of demodulated bits. In some aspects, 1404 may be performed by the probabilistic shaping component 199.

At 1406, the network entity may perform, based on the set of demodulated bits and a TB associated with the set of demodulated bits, an inverse probabilistic shaping process to obtain a set of data bits for the signal. For example, referring to FIG. 11, the network entity (base station 1104) may perform, at 1134, based on the set of demodulated bits and a TB associated with the set of demodulated bits, an inverse probabilistic shaping process to obtain a set of data bits for the signal. In some aspects, 1406 may be performed by the probabilistic shaping component 199.

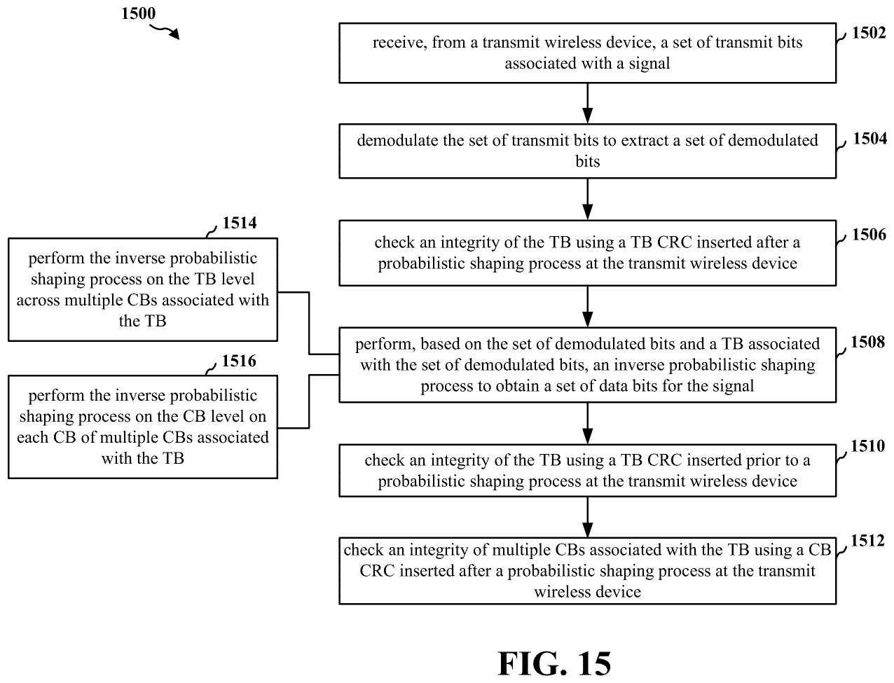

FIG. 15 is a flowchart 1500 illustrating methods of wireless communication at a receiving wireless device in accordance with various aspects of the present disclosure. The method may be performed by the receiving wireless device. In some aspects, the receiving wireless device may be a network entity, which may be a base station, or a component of a base station, in the access network of FIG. 1 or a core network component (e.g., base station 102, 310, 1104; or the network entity 1602 in the hardware implementation of FIG. 16). The method provides flexible and adaptive integration of the probabilistic shaping process, including various options for CRC insertion, rate matching, and segmentation for probabilistic shaping, into existing and new communication systems. The method improves the efficiency, throughput, and latency of wireless communication.

In FIG. 15, at 1502, the network entity may receive, from a transmitting wireless device, a set of transmit bits associated with a signal. In some aspects, the transmitting wireless device may be a UE. The UE may be the UE 104, 350, 1102, or the apparatus 1604 in the hardware implementation of FIG. 16. FIGS. 9A, 9B, 10, and 11 illustrate various aspects in connection with flowchart 1500. For example, referring to FIG. 11, the network entity (base station 1104) may receive, at 1128, from a transmitting wireless device (UE 1102), a set of transmit bits associated with a signal. In some aspects, 1502 may be performed by the probabilistic shaping component 199.

At 1504, the network entity may demodulate the set of transmit bits to extract a set of demodulated bits. For example, referring to FIG. 11, the network entity (base station 1104) may demodulate, at 1130, the set of transmit bits to extract a set of demodulated bits. In some aspects, 1504 may be performed by the probabilistic shaping component 199.

At 1508, the network entity may perform, based on the set of demodulated bits and a TB associated with the set of demodulated bits, an inverse probabilistic shaping process to obtain a set of data bits for the signal. For example, referring to FIG. 11, the network entity (base station 1104) may perform, at 1134, based on the set of demodulated bits and a TB associated with the set of demodulated bits, an inverse probabilistic shaping process to obtain a set of data bits for the signal. In some aspects, 1508 may be performed by the probabilistic shaping component 199.

In some aspects, at 1510, the network entity may check, after performing the inverse probabilistic shaping process (at 1508), the integrity of the TB using a TB CRC inserted prior to a probabilistic shaping process at the UE. For example, referring to FIG. 11, the network entity (base station 1104) may check, at 1136, after performing the inverse probabilistic shaping process (at 1134), the integrity of the TB using a TB CRC inserted prior to a probabilistic shaping process (1116) at the UE 1102. In some aspects, 1510 may be performed by the probabilistic shaping component 199.

In some aspects, at 1506, the network entity may check, before performing the inverse probabilistic shaping process (at 1508), the integrity of the TB using a TB CRC inserted after a probabilistic shaping process at the UE. For example, referring to FIG. 11, the network entity (base station 1104) may check, at 1132, before performing the inverse probabilistic shaping process (at 1134), the integrity of the TB using a TB CRC inserted after a probabilistic shaping process (1116) at the UE 1102. In some aspects, 1506 may be performed by the probabilistic shaping component 199.

In some aspects, the network entity may check, at 1506, before performing the inverse probabilistic shaping process (at 1508), the integrity of the TB using a first TB CRC inserted prior to a probabilistic shaping process at the UE, and check, at 1510, after performing the inverse probabilistic shaping process (at 1508), the integrity of the TB using a second TB CRC inserted after the probabilistic shaping process at the UE. For example, referring to FIG. 11, the network entity (base station 1104) may check, at 1132, before performing the inverse probabilistic shaping process (at 1134), the integrity of the TB using a first TB CRC inserted prior to a probabilistic shaping process (1116) at the UE 1102, and check, at 1136, after performing the inverse probabilistic shaping process (at 1134), the integrity of the TB using a second TB CRC inserted after the probabilistic shaping process (1116) at the UE 1102.

In some aspects, at 1512, the network entity may check the integrity of multiple CBs associated with the TB using a CB CRC inserted after a probabilistic shaping process at the UE. For example, referring to FIG. 11, the network entity (base station 1104) may check, at 1138 the integrity of multiple CBs associated with the TB using a CB CRC inserted (at 1120) after a probabilistic shaping process (1116) at the UE 1102. In some aspects, 1512 may be performed by the probabilistic shaping component 199.

In some aspects, to perform the inverse probabilistic shaping process (at 1508), the network entity may be configured to: perform, at 1514, the inverse probabilistic shaping process on a TB level across multiple CBs associated with the TB. For example, referring to FIG. 11, when performing the inverse probabilistic shaping process (at 1134), the network entity (base station 1104) may perform the inverse probabilistic shaping process on a TB level across multiple CBs associated with the TB. In some aspects, 1514 may be performed by the probabilistic shaping component 199.

In some aspects, to perform the inverse probabilistic shaping process (at 1508), the network entity may be configured to: perform, at 1516, the inverse probabilistic shaping process on a CB level on each CB of multiple CBs associated with the TB. For example, referring to FIG. 11, when performing the inverse probabilistic shaping process (at 1134), the network entity (base station 1104) may perform the inverse probabilistic shaping process on a CB level each CB of multiple CBs associated with the TB. In some aspects, 1516 may be performed by the probabilistic shaping component 199.

FIG. 16 is a diagram 1600 illustrating an example of a hardware implementation for an apparatus 1604. The apparatus 1604 may be a transmitting wireless device. In some aspects, the transmitting wireless device may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the component 198 may be configured to determine, based at least in part on a first parameter associated with an FEC process and a second parameter associated with a probabilistic shaping process, a TB size for a TB associated with a signal to be transmitted to a receiving wireless device; perform the probabilistic shaping process on a first set of data bits of the signal on the TB to obtain a second set of transmit bits, wherein a TB CRC is inserted into the TB before or after the probabilistic shaping process, and wherein the probabilistic shaping process is applied on a TB level across multiple CBs associated with the TB or on a CB level individually inside each CB of the multiple CBs; and transmit, to the receiving wireless device, the signal using the second set of transmit bits. The component 198 may be further configured to perform any of the aspects described in connection with the flowcharts in FIG. 12 and FIG. 13, and/or performed by the UE 1102 in FIG. 11. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, includes means for determining, based at least in part on a first parameter associated with an FEC process and a second parameter associated with a probabilistic shaping process, a TB size for a TB associated with a signal to be transmitted to a receiving wireless device, means for performing the probabilistic shaping process on a first set of data bits of the signal on the TB to obtain a second set of transmit bits, where a TB CRC is inserted into the TB before or after the probabilistic shaping process, and where the probabilistic shaping process is applied on a TB level across multiple CBs associated with the TB or on a CB level individually inside each CB of the multiple CBs, and means for transmitting, to the receiving wireless device, the signal using the second set of transmit bits. The apparatus 1604 may further include means for performing any of the aspects described in connection with the flowcharts in FIG. 12 and FIG. 13, and/or aspects performed by the UE 1102 in FIG. 11. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

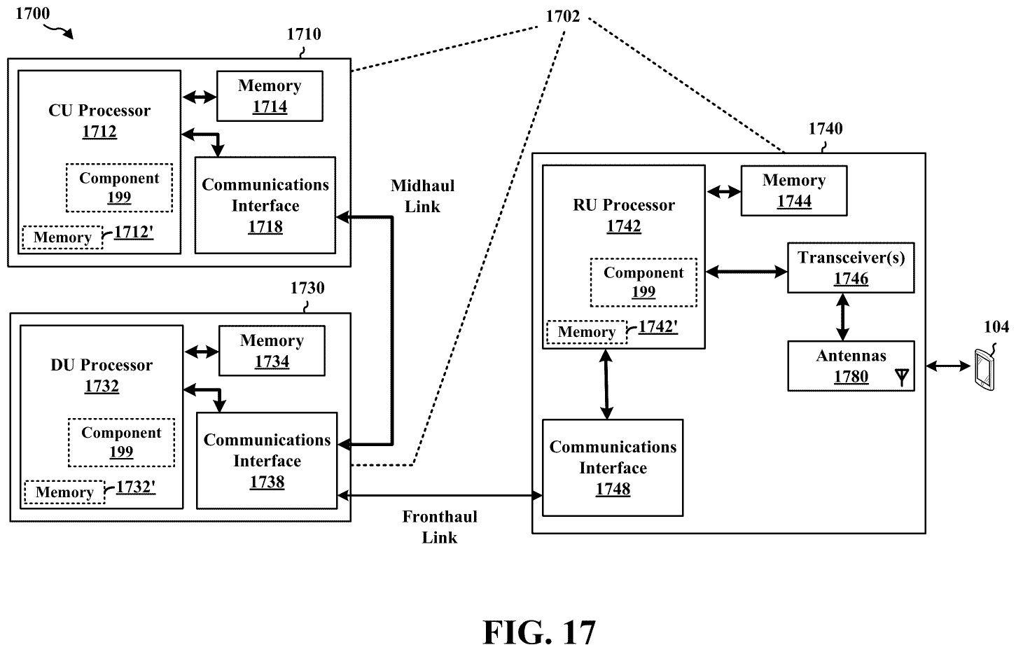

FIG. 17 is a diagram 1700 illustrating an example of a hardware implementation for a receiving wireless device. In some aspects, the receiving wireless device may be a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a transmitting wireless device, a set of transmit bits associated with a signal; demodulate the set of transmit bits to extract a set of demodulated bits; and perform, based on the set of demodulated bits and a TB associated with the set of demodulated bits, an inverse probabilistic shaping process to obtain a set of data bits for the signal. The component 199 may be further configured to perform any of the aspects described in connection with the flowcharts in FIG. 14 and FIG. 15, and/or performed by the base station 1104 in FIG. 11. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for receiving, from a transmitting wireless device, a set of transmit bits associated with a signal, means for demodulating the set of transmit bits to extract a set of demodulated bits, and means for performing, based on the set of demodulated bits and a TB associated with the set of demodulated bits, an inverse probabilistic shaping process to obtain a set of data bits for the signal. The network entity 1702 may further include means for performing any of the aspects described in connection with the flowcharts in FIG. 14 and FIG. 15, and/or aspects performed by the base station 1104 in FIG. 11. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include determining, based at least in part on a first parameter associated with an FEC process and a second parameter associated with a probabilistic shaping process, a TB size for a TB associated with a signal to be transmitted to a receiving wireless device; performing the probabilistic shaping process on a first set of data bits of the signal on the TB to obtain a second set of transmit bits, wherein a TB CRC is inserted into the TB before or after the probabilistic shaping process, and wherein the probabilistic shaping process is applied on a TB level across multiple CBs associated with the TB or on a CB level individually inside each CB of the multiple CBs; and transmitting, to the receiving wireless device, the signal using the second set of transmit bits. The method provides flexible and adaptive integration of the probabilistic shaping process, including various options for CRC insertion, rate matching, and segmentation for probabilistic shaping, into existing and new communication systems. The method improves the efficiency, throughput, and latency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a transmitting wireless device. The method may include determining, based at least in part on a first parameter associated with a Forward Error Correction (FEC) process and a second parameter associated with a probabilistic shaping process, a transport block (TB) size for a TB associated with a signal to be transmitted to a receiving wireless device; performing the probabilistic shaping process on a first set of data bits of the signal on the TB to obtain a second set of transmit bits, wherein a TB cyclic redundancy check (CRC) is inserted into the TB before or after the probabilistic shaping process, and wherein the probabilistic shaping process is applied on a TB level across multiple code blocks (CBs) associated with the TB or on a CB level individually inside each CB of the multiple CBs; and transmitting, to the receiving wireless device, the signal using the second set of transmit bits.

Aspect 2 is the method of aspect 1, wherein determining the TB size may include: determining a first number of bits consumed by the FEC process based at least in part on the first parameter; and determining, based at least in part on the first number of bits, the TB size.

Aspect 3 is the method of aspect 2, wherein determining, based at least in part on the first number of bits, the TB size may include: determining a second number of data bits serviced for Medium Access Control (MAC) based on the first number of bits and a shaping rate; and determining the TB size based on the second number of data bits.

Aspect 4 is the method of aspect 3, wherein determining the second number of data bits may include: determining a third number of CBs associated with the first number of bits, an unencoded CB size before coding, and a coded CB size after coding; determining a fourth number of information bits per CB based on a shaped number of information bits to be shaped and an unshaped number of information bits that are not shaped; and determining the second number of data bits based on the fourth number of information bits.

Aspect 5 is the method of aspect 4, wherein determining the fourth number of information bits per CB may include: determining the fourth number of information bits per CB using a same coded CB size for all the CBs of the multiple CBs.

Aspect 6 is the method of aspect 4, wherein performing the probabilistic shaping process may include: performing the probabilistic shaping process using a same coded CB size for all the CBs of the multiple CBs.

Aspect 7 is the method of any of aspects 1 to 6, wherein the method may further include, prior to transmitting the signal using the second set of transmit bits: performing a first rate matching using a same channel code and a same coded CB size for all the CBs of the multiple CBs; and performing a second rate matching on a subset of CBs from the multiple CBs by adding or removing one or more modulation symbols associated with the subset of CBs.

Aspect 8 is the method of aspect 7, wherein performing the second rate matching on the subset of CBs may include: performing the second rate matching by removing the one or more modulation symbols associated with the subset of CBs, and wherein removing the one or more modulation symbols may include: removing one or more systematic bits associated with one or more removed modulation symbols.

Aspect 9 is the method of aspect 7, wherein the coded CB size may be a largest number of resource elements (REs) that one CB of the multiple CBs occupies, and wherein system bits and parity bits may be removed for the CBs occupying a second number of REs less than the largest number.

Aspect 10 is the method of aspect 7, wherein the coded CB size may be a smallest number of resource elements (REs) that one CB of the multiple CBs occupies, and wherein an additional modulation symbol containing all parity bits may be transmitted on the CBs occupying a third number of REs larger that the smallest number.

Aspect 11 is the method of any of aspects 1 to 10, wherein the method may further include inserting the TB CRC onto the TB prior to the probabilistic shaping process.

Aspect 12 is the method of any of aspects 1 to 10, wherein the method may further include inserting the TB CRC onto the TB after the probabilistic shaping process.

Aspect 13 is the method of any of aspects 1 to 10, wherein the method may further include inserting a first TB CRC onto the TB prior to the probabilistic shaping process, and inserting a second TB CRC onto the TB after the probabilistic shaping process.

Aspect 14 is the method of any of aspects 1 to 13, wherein the method may further include inserting a CB CRC onto the multiple CBs after the probabilistic shaping process.

Aspect 15 is the method of any of aspects 1 to 14, wherein performing the probabilistic shaping process may include: performing the probabilistic shaping process on the TB level across the multiple CBs associated with the TB, comprising: performing the probabilistic shaping process on the TB; and segmenting, after the probabilistic shaping process, each TB of the TB into multiple CBs.

Aspect 16 is the method of any of aspects 1 to 14, wherein performing the probabilistic shaping process may include: performing the probabilistic shaping process on the CB level inside each CB of the multiple CBs individually, comprising: segmenting each TB of the TB into multiple CBs; and performing, for each TB of the TB, the probabilistic shaping process on each CB of the multiple CBs associated with a corresponding TB.

Aspect 17 is the method of any of aspects 1 to 14, wherein performing the probabilistic shaping process on the first set of data bits of the signal may include: dividing the first set of data bits into a predetermined number of shaping blocks (SBs); and performing the probabilistic shaping process on the first set of data bits based on the predetermined number of SBs, wherein each SB has a same shaping configuration for the probabilistic shaping process.

Aspect 18 is the method of any of aspects 1 to 17, wherein the probabilistic shaping process may be implemented using probabilistic amplitude shaping (PAS) based on a Maxwell-Boltzmann distribution.

Aspect 19 is an apparatus for wireless communication at a transmitting wireless device, including: at least one memory; and at least one processor coupled to the at least one memory and, based at least in part on information stored in the at least one memory, the at least one processor is configured to perform the method of any of aspects 1-18.

Aspect 20 is the apparatus of aspect 19, further including at least one of a transceiver or an antenna coupled to the at least one processor and configured to transmit the signal using the second set of transmit bits.

Aspect 21 is an apparatus for wireless communication including means for implementing the method of any of aspects 1-18.

Aspect 22 is a computer-readable medium (e.g., a non-transitory computer-readable medium) storing computer executable code, where the code when executed by a processor causes the processor to implement the method of any of aspects 1-18.

Aspect 23 is a method of wireless communication at a receiving wireless device. The method may include receiving, from a transmitting wireless device, a set of transmit bits associated with a signal; demodulating the set of transmit bits to extract a set of demodulated bits; and performing, based on the set of demodulated bits and a transport block (TB) associated with the set of demodulated bits, an inverse probabilistic shaping process to obtain a set of data bits for the signal.

Aspect 24 is the method of aspect 23, wherein the method may further include checking, after performing the inverse probabilistic shaping process, an integrity of the TB using a TB cyclic redundancy check (CRC) inserted prior to a probabilistic shaping process at the transmitting wireless device.

Aspect 25 is the method of aspect 23, wherein the method may further include checking, before performing the inverse probabilistic shaping process, an integrity of the TB using a TB cyclic redundancy check (CRC) inserted after a probabilistic shaping process at the transmitting wireless device.

Aspect 26 is the method of aspect 23, wherein the method may further include checking, before performing the inverse probabilistic shaping process, an integrity of the TB using a first TB cyclic redundancy check (CRC) inserted prior to a probabilistic shaping process at the transmitting wireless device, and checking, after performing the inverse probabilistic shaping process, the integrity of the TB using a second TB CRC inserted after the probabilistic shaping process at the transmitting wireless device.

Aspect 27 is the method of aspect 23, wherein the method may further include checking an integrity of multiple code blocks (CBs) associated with the TB using a CB cyclic redundancy check (CRC) inserted after a probabilistic shaping process at the transmitting wireless device.

Aspect 28 is the method of aspect 23, wherein performing the inverse probabilistic shaping process may include: performing the inverse probabilistic shaping process on a TB level across multiple code blocks (CBs) associated with the TB.

Aspect 29 is the method of aspect 23, wherein performing the inverse probabilistic shaping process may include: performing the inverse probabilistic shaping process on a code block (CB) level on each CB of multiple CBs associated with the TB.

Aspect 30 is the method of aspect 23, wherein performing the inverse probabilistic shaping process may include: performing the inverse probabilistic shaping process based on a predetermined number of shaping blocks (SBs), wherein each SB has a same configuration for the inverse probabilistic shaping process.

Aspect 31 is an apparatus for wireless communication at a receiving wireless device, including: at least one memory; and at least one processor coupled to the at least one memory and, based at least in part on information stored in the at least one memory, the at least one processor is configured to perform the method of any of aspects 23-30.

Aspect 32 is the apparatus of aspect 31, further including at least one of a transceiver or an antenna coupled to the at least one processor and configured to output the indication of the adjusted type.

Aspect 33 is an apparatus for wireless communication including means for implementing the method of any of aspects 23-30.

Aspect 34 is a computer-readable medium (e.g., a non-transitory computer-readable medium) storing computer executable code, where the code when executed by a processor causes the processor to implement the method of any of aspects 23-30.

What is claimed is:

1. An apparatus of wireless communication at a transmitting wireless device, comprising:
at least one memory; and
at least one processor coupled to the at least one memory and, based at least in part on information stored in the at least one memory, the at least one processor is configured to:
determine, based at least in part on a first parameter associated with a Forward Error Correction (FEC) process and a second parameter associated with a probabilistic shaping process, a transport block (TB) size for a TB associated with a signal to be transmitted to a receiving wireless device;
perform the probabilistic shaping process on a first set of data bits of the signal on the TB to obtain a second set of transmit bits, wherein a TB cyclic redundancy check (CRC) is inserted into the TB before or after the probabilistic shaping process, and wherein the probabilistic shaping process is applied on a TB level across multiple code blocks (CBs) associated with the TB or on a CB level individually inside each CB of the multiple CBs; and
transmit, to the receiving wireless device, the signal using the second set of transmit bits.

2. The apparatus of claim 1, further comprising a transceiver coupled to the at least one processor, wherein, to transmit the signal using the second set of transmit bits, the at least one processor is configured to transmit, via the transceiver, the signal using the second set of transmit bits, and wherein, to determine the TB size, the at least one processor is configured to:
determine a first number of bits consumed by the FEC process based at least in part on the first parameter; and
determine, based at least in part on the first number of bits, the TB size.

3. The apparatus of claim 2, wherein, to determine, based at least in part on the first number of bits, the TB size, the at least one processor is configured to:
determine a second number of data bits serviced for Medium Access Control (MAC) based on the first number of bits and a shaping rate; and
determine the TB size based on the second number of data bits.

4. The apparatus of claim 3, wherein, to determine the second number of data bits, the at least one processor is configured to:
determine a third number of CBs associated with the first number of bits, an unencoded CB size before coding, and a coded CB size after coding;
determine a fourth number of information bits per CB based on a shaped number of information bits to be shaped and an unshaped number of information bits that are not shaped; and
determine the second number of data bits based on the fourth number of information bits.

5. The apparatus of claim 4, wherein, to determine the fourth number of information bits per CB, the at least one processor is configured to:
determine the fourth number of information bits per CB using a same coded CB size for all the CBs of the multiple CBs.

6. The apparatus of claim 4, wherein, to perform the probabilistic shaping process, the at least one processor is configured to:
perform the probabilistic shaping process using a same coded CB size for all the CBs of the multiple CBs.

7. The apparatus of claim 4, wherein the at least one processor is further configured to, prior to being configured to transmit the signal using the second set of transmit bits:
perform a first rate matching using a same channel code and a same coded CB size for all the CBs of the multiple CBs; and
perform a second rate matching on a subset of CBs from the multiple CBs by adding or removing one or more modulation symbols associated with the subset of CBs.

8. The apparatus of claim 7, wherein, to perform the second rate matching on the subset of CBs, the at least one processor is configured to:
perform the second rate matching by removing the one or more modulation symbols associated with the subset of CBs, and wherein, to remove the one or more modulation symbols, the at least one processor is configured to:
remove one or more systematic bits associated with one or more removed modulation symbols.

9. The apparatus of claim 7, wherein the coded CB size is a largest number of resource elements (REs) that one CB of the multiple CBs occupies, and wherein system bits and parity bits are removed for the CBs occupying a second number of REs less than the largest number of REs.

10. The apparatus of claim 7, wherein the coded CB size is a smallest number of resource elements (REs) that one CB of the multiple CBs occupies, and wherein an additional modulation symbol containing all parity bits are transmitted on the CBs occupying a third number of REs larger that the smallest number of REs.

11. The apparatus of claim 1, wherein the at least one processor is further configured to:
insert the TB CRC onto the TB prior to the probabilistic shaping process.

12. The apparatus of claim 1, wherein the at least one processor is further configured to:
insert the TB CRC onto the TB after the probabilistic shaping process.

13. The apparatus of claim 1, wherein the at least one processor is further configured to:
insert a first TB CRC onto the TB prior to the probabilistic shaping process, and insert a second TB CRC onto the TB after the probabilistic shaping process.

14. The apparatus of claim 1, wherein the at least one processor is further configured to:
insert a CB CRC onto the multiple CBs after the probabilistic shaping process.

15. The apparatus of claim 1, wherein, to perform the probabilistic shaping process, the at least one processor is configured to:
perform the probabilistic shaping process on the TB level across the multiple CBs associated with the TB, comprising:
performing the probabilistic shaping process on the TB; and
segmenting, after the probabilistic shaping process, each TB of the TB into multiple CBs.

16. The apparatus of claim 1, wherein, to perform the probabilistic shaping process, the at least one processor is configured to:
perform the probabilistic shaping process on the CB level inside each CB of the multiple CBs individually, comprising:
segmenting each TB of the TB into multiple CBs; and
performing, for each TB of the TB, the probabilistic shaping process on each CB of the multiple CBs associated with a corresponding TB.

17. The apparatus of claim 1, wherein, to perform the probabilistic shaping process on the first set of data bits of the signal, the at least one processor is configured to:
divide the first set of data bits into a predetermined number of shaping blocks (SBs); and
perform the probabilistic shaping process on the first set of data bits based on the predetermined number of SBs, wherein each SB has a same shaping configuration for the probabilistic shaping process.

18. The apparatus of claim 1, wherein the probabilistic shaping process is implemented using probabilistic amplitude shaping (PAS) based on a Maxwell-Boltzmann distribution.

19. An apparatus of wireless communication at a receiving wireless device, comprising:
at least one memory; and
at least one processor coupled to the at least one memory and, based at least in part on information stored in the at least one memory, the at least one processor is configured to:
receive, from a transmitting wireless device, a set of transmit bits associated with a signal;
demodulate the set of transmit bits to extract a set of demodulated bits; and
perform, based on the set of demodulated bits and a transport block (TB) associated with the set of demodulated bits, an inverse probabilistic shaping process to obtain a set of data bits for the signal.

20. The apparatus of claim 19, further comprising a transceiver coupled to the at least one processor, wherein, to receive the set of transmit bits associated with the signal, the at least one processor is configured to receive, via the transceiver, the set of transmit bits associated with the signal, and wherein the at least one processor is further configured to:
check, after performing the inverse probabilistic shaping process, an integrity of the TB using a TB cyclic redundancy check (CRC) inserted prior to a probabilistic shaping process at the transmitting wireless device.

21. The apparatus of claim 19, wherein the at least one processor is further configured to:
check, before performing the inverse probabilistic shaping process, an integrity of the TB using a TB cyclic redundancy check (CRC) inserted after a probabilistic shaping process at the transmitting wireless device.

22. The apparatus of claim 19, wherein the at least one processor is further configured to:
check, before performing the inverse probabilistic shaping process, an integrity of the TB using a first TB cyclic redundancy check (CRC) inserted prior to a probabilistic shaping process at the transmitting wireless device, and
check, after performing the inverse probabilistic shaping process, the integrity of the TB using a second TB CRC inserted after the probabilistic shaping process at the transmitting wireless device.

23. The apparatus of claim 19, wherein the at least one processor is further configured to:
check an integrity of multiple code blocks (CBs) associated with the TB using a CB cyclic redundancy check (CRC) inserted after a probabilistic shaping process at the transmitting wireless device.

24. The apparatus of claim 19, wherein, to perform the inverse probabilistic shaping process, the at least one processor is configured to:
perform the inverse probabilistic shaping process on a TB level across multiple code blocks (CBs) associated with the TB.

25. The apparatus of claim 19, wherein, to perform the inverse probabilistic shaping process, the at least one processor is configured to:
perform the inverse probabilistic shaping process on a code block (CB) level on each CB of multiple CBs associated with the TB.

26. The apparatus of claim 19, wherein, to perform the inverse probabilistic shaping process, the at least one processor is configured to:
perform the inverse probabilistic shaping process based on a predetermined number of shaping blocks (SBs), wherein each SB has a same configuration for the inverse probabilistic shaping process.

27. A method of wireless communication at a transmitting wireless device, comprising:
determining, based at least in part on a first parameter associated with a Forward Error Correction (FEC) process and a second parameter associated with a probabilistic shaping process, a transport block (TB) size for a TB associated with a signal to be transmitted to a receiving wireless device;
performing the probabilistic shaping process on a first set of data bits of the signal on the TB to obtain a second set of transmit bits, wherein a TB cyclic redundancy check (CRC) is inserted into the TB before or after the probabilistic shaping process, and wherein the probabilistic shaping process is applied on a TB level across multiple code blocks (CBs) associated with the TB or on a CB level individually inside each CB of the multiple CBs; and
transmitting, to the receiving wireless device, the signal using the second set of transmit bits.

28. The method of claim 27, wherein determining the TB size comprises:
determining a first number of bits consumed by the FEC process based at least in part on the first parameter; and
determining, based at least in part on the first number of bits, the TB size.

29. A method of wireless communication at a receiving wireless device, comprising:
receiving, from a transmitting wireless device, a set of transmit bits associated with a signal;
demodulating the set of transmit bits to extract a set of demodulated bits; and
performing, based on the set of demodulated bits and a transport block (TB) associated with the set of demodulated bits, an inverse probabilistic shaping process to obtain a set of data bits for the signal.

30. The method of claim 29, further comprising:
checking, after performing the inverse probabilistic shaping process, an integrity of the TB using a TB cyclic redundancy check (CRC) inserted prior to a probabilistic shaping process at the transmitting wireless device.
